(19) United States
(12) Patent Application Publication
(10) Pub. No.: US 2018/0127556 A1
(43) Pub. Date: May 10, 2018

(54) MASTERBATCH CONTAINING CARBON NANOTUBES AS BLACK PIGMENT

(71) Applicant: PolyOne - Shanghai, China, Shanghai (CN)

(72) Inventors: Mengge LIU, Shanghai (CN); Wenyu SHANG, Shanghai (CN); Ling (Julynn) ZHU, Shanghai (CN)

(21) Appl. No.: 15/567,039

(22) PCT Filed: Apr. 15, 2016
(86) PCT No.: PCT/CN16/79360

§ 371 Date: Oct. 16, 2017

(30) Foreign Application Priority Data
Apr. 17, 2015 (CN) 201510185247.X

(51) Int. Cl. C08J 3/22; C08L 101/00; C08K 7/24; C08K 3/04

(52) U.S. Cl. CPC C08J 3/226; C08L 101/00; B82Y 30/00; C08K 3/041; C08K 7/24

(57) ABSTRACT

A masterbatch and its thermoplastic compound are formulated with carbon nanotubes as black pigment. When the masterbatch is let down into additional thermoplastic resin to form a polymer compound, the carbon nanotubes provide substantially the same L* Value of blackness as does carbon black with about thirty times less weight percent of carbon nanotubes compared with carbon black.

### CLAIM OF PRIORITY

This application claims priority from Chinese Patent Application Serial Number 201510185247.X bearing PolyOne Attorney Docket Number 1201511CN and filed on Apr. 17, 2015, which is incorporated by reference.

### FIELD OF THE INVENTION

This invention relates to masterbatches containing carbon nanotubes for use as a black pigment masterbatch.

### BACKGROUND OF THE INVENTION

Plastic has taken the place of other materials in a variety of industries. In the packaging industry, plastic has replaced glass to minimize breakage, reduce weight, and reduce energy consumed in manufacturing and transport. In other industries, plastic has replaced metal to minimize corrosion, reduce weight, and provide color-in-bulk products.

Many plastic articles are colorful because of the use of colorants as functional additives in the thermoplastic compound of multiple ingredients. Colorful plastic articles are useful in marketing to attract attention, based on striking and noticeable colors in packaging, and performance, based on color coding to signify different performance properties such as gauge of wire or cable.

Color standards permit confident reproducibility of color in plastic articles. One standard is the CIE-Lab Color System, in which L* identifies the darkness-lightness gray scale; a* identifies the green-red scale; and b* identifies the blue-yellow scale. Within the gray scale, the lower the number, the darker the appearance of the color in the plastic article. Practical limits for the lowest L* value is about 20-25 even with increasing content of conventional black pigments, such as carbon black.

Another form of carbon is the carbon nanotube, which is being intensely evaluated for a variety of thermoplastic engineering purposes. Carbon nanotubes have been identified also as a good black colorant.

### SUMMARY OF THE INVENTION

What the art needs is a black colorant which can maximize possible darkness in a plastic article.

The present invention has found that carbon nanotubes are about thirty times more effective than carbon black in achieving darkness of L*=20-25 in a plastic article.

One aspect of the invention is a masterbatch, comprising: (a) thermoplastic carrier, (b) carbon nanotubes in a weight percent about thirty times less than carbon black would be used to achieve the substantially the same L* value.

Features will become apparent from a description of the embodiments of the invention.

### EMBODIMENTS OF THE INVENTION

Masterbatch for Carbon Nanotube Colorant Additive

Thermoplastic Polymer Carrier Resin

Any thermoplastic resin is a candidate for the carrier resin for the masterbatch because there is a desire for any of these resins to also be the material into which the masterbatch is melt-mixed. The resin can be ethylene vinyl acetate (EVA), polypropylene (PP), polyethylene (PE), polyvinyl chloride (PVC), polycarbonate (PC), acrylonitrile-butadiene-styrene (ABS), polyethylene terephthalate (PET), polybutylene terephthalate (PBT), polyoxymethylene (POM), polyamide (PA), polystyrene (PS), polymethylmethacrylate (PMMA), polyphenylene sulfide (PPS), polylactic acid (PLA), any copolymer of any of them, and any combination thereof; or other second material serving as a carrier resin.

The resin can have a weight average molecular weight ranging from about 3000 to about 3×10⁶, and preferably from about 50,000 to about 500,000.

The resin can have a glass transition temperature ranging from about −100° C. to about 300° C., and preferably from about −50° C. to about 200° C.

The resin can have a particle size ranging from about 10 to about 10,000 microns, and preferably from about 500 to about 5000 microns.

Non-limiting examples of commercially available thermoplastic resins includes polypropylene polymer from Jin Shan.

Carbon Nanotubes

Carbon nanotubes can be multi-walled, single-walled, open-ended, or close-ended.

Carbon nanotubes are sold in commercial quantities by Union Chemical Ind. Co. Ltd.

Optional Other Colorants

Depending on the coloration desired in the final compound, other colorant masterbatches containing other colors can be used at the time of melt-mixing of the thermoplastic compound. Alternatively, the additional color(s) can be including in the masterbatch which contains the carbon nanotubes.

Optional Other Ingredients

In addition to colorants, a number of other functional additives can be added to the masterbatch for later melt-mixing with the thermoplastic matrix. The amounts and types of other functional additives are identified below with respect to their usefulness in the final thermoplastic compound.

Table 1 shows acceptable, desirable, and preferable ranges of ingredients useful in the present invention, all expressed in weight percent (wt. %) of the masterbatch. The masterbatch can comprise, consist essentially of, or consist of these ingredients. Any number between the ends of the ranges is also contemplated as an end of a range, such that all possible combinations are contemplated within the possibilities of Table 1 as candidate masterbatches for use in this invention.

TABLE 1
Masterbatch

| | Acceptable | Desirable | Preferred |
|---|---|---|---|
| Ingredient (Wt. %) | Range | Range | Range |
| Carrier Resin | 40-99.9 | 60-99.8 | 75-99.5 |
| Carbon Nanotubes | 0.1-60 | 0.5-40 | 1-25 |
| Optional Other Pigments | 0-15 | 0-12 | 0-10 |
| Optional Other | 0-10 | 0-8 | 0-5 |
| Ingredients | | | |

Preparation of Masterbatch

The preparation of masterbatches of the present invention is uncomplicated. The masterbatch of the present invention can be made in batch or continuous operations.

Mixing in a continuous process typically occurs in a single or twin screw extruder that is elevated to a temperature that is sufficient to melt the polymer matrix with addition of other ingredients either at the head of the extruder or downstream in the extruder. Extruder speeds can range from about 50 to about 500 revolutions per minute (rpm), and preferably from about 100 to about 300 rpm. Typically, the output from the extruder is pelletized for later extrusion or molding into polymeric articles.

Mixing in a batch process typically occurs in a Banbury mixer that is capable of operating at a temperature that is sufficient to melt the polymer matrix to permit addition of the solid ingredient additives. The mixing speeds range from 60 to 1000 rpm. Also, the output from the mixer is chopped into smaller sizes for later extrusion or molding into polymeric articles.

Compounds and Uses of Compounds

Any of the masterbatches loaded with carbon nanotubes described above can be melt-mixed with a thermoplastic resin and optionally other ingredients.

Candidate thermoplastic resins can be polypropylene (PP), polyethylene(PE), polyvinyl chloride (PVC), polycarbonate (PC), acrylonitrile-butadiene-styrene (ABS), polyethylene terephthalate (PET), polybutylene terephthalate (PBT), polyoxymethylene (POM), polyamide (PA), polystyrene (PS), polymethylmethacrylate (PMMA), polyphenylene sulfide (PPS) or polylactic acid (PLA), any copolymer of any of them, or any combination thereof.

The compound can also contain one or more conventional plastics additives in an amount that is sufficient to obtain a desired processing or performance property for the thermoplastic compound. The amount should not be wasteful of the additive or detrimental to the processing or performance of the compound. Those skilled in the art of thermoplastics compounding, without undue experimentation but with reference to such treatises as Plastics Additives Database (2004) from Plastics Design Library (elsevier.com), can select from many different types of additives for inclusion into the compounds of the present invention.

Non-limiting examples of optional additives include adhesion promoters; biocides (antibacterials, fungicides, and mildewcides), anti-fogging agents; anti-static agents; bonding, blowing and foaming agents; dispersants; fillers, fibers, and extenders; flame retardants; smoke suppresants; impact modifiers; initiators; lubricants; micas; pigments, colorants and dyes; plasticizers; processing aids; release agents; silanes coupling agents, titanates and zirconates coupling agents; slip and anti-blocking agents; stabilizers; stearates; ultraviolet light absorbers; viscosity regulators; PE waxes; catalyst deactivators, and combinations of them.

The final thermoplastic compound can comprise, consist essentially of, or consist of any one or more of the thermoplastic resins, in combination with any one or more optional functional additives. Any number between the ends of the ranges is also contemplated as an end of a range, such that all possible combinations are contemplated within the possibilities of Table 2 as candidate compounds for use in this invention. Let down ratios of masterbatch into thermoplastic resins can range from about 2:1 to about 400:1 (about 50% LDR to about 0.25% LDR) depending on desired final loading and usage rate to achieve that final loading of carbon nanotubes as pigment for the thermoplastic compound.

TABLE 2
Compound

| Ingredient | Acceptable | Desirable | Preferable |
|---|---|---|---|
| Thermoplastic Resin(s) | 65-99.99% | 80-99.48% | 93-98.97% |
| Carbon Nanotubes | 0.01-10% | 0.02-5% | 0.03-2% |
| Optional Other Colorants | 0-10% | 0.5-5% | 1-3% |
| Optional Functional | 0-15% | 0-10% | 0-2% |
| Additive(s) | | | |

Processing

The preparation of finally shaped plastic articles is uncomplicated and can be made in batch or continuous operations.

Extrusion, as a continuous operation, and molding techniques, as a batch operation, are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (elsevier.com), one can make articles of any conceivable shape and appearance using compounds of the present invention.

The compound can be made into any extruded, molded, spun, casted, calendered, thermoformed, or 3D-printed article. Key to this combination is that the carbon nanotubes can reduce the amount of black colorant by as much as about 30 times, as compared with the amount of conventional carbon black to achieve substantially the same L* value.

Candidate end uses for such finally-shaped thermoplastic articles are listed in summary fashion below.

Appliances: Refrigerators, freezers, washers, dryers, toasters, blenders, vacuum cleaners, coffee makers, and mixers;

Building and Construction: Fences, decks and rails, floors, floor covering, pipes and fittings, siding, trim, windows, doors, molding, and wall coverings;

Consumer Goods: Power hand tools, rakes, shovels, lawn mowers, shoes, boots, golf clubs, fishing poles, and watercraft;

Electrical/Electronic Devices: Printers, computers, business equipment, LCD projectors, mobile phones, connectors, chip trays, circuit breakers, and plugs;

Healthcare: Wheelchairs, beds, testing equipment, analyzers, labware, ostomy, IV sets, wound care, drug delivery, inhalers, and packaging;

Industrial Products: Containers, bottles, drums, material handling, gears, bearings, gaskets and seals, valves, wind turbines, and safety equipment;

Consumer Packaging: Food and beverage, cosmetic, detergents and cleaners, personal care, pharmaceutical and wellness containers;

Transportation: Automotive aftermarket parts, bumpers, window seals, instrument panels, consoles, under hood electrical, and engine covers; and

Wire and Cable: Cars and trucks, airplanes, aerospace, construction, military, telecommunication, utility power, alternative energy, and electronics.

Examples explain the preparation of the masterbatch and compound.

### Examples

Example 1 and Comparative Example A were masterbatches made by melt-mixing the carrier resin(s) and carbon material at a temperature of 190-230° C. using a twin screw extruder which formed pellets.

TABLE 3

| | Comparative | |
|---|---|---|
| Ingredient (Wt. %) | Example A | Example 1 |
| PP-Y-3700 Polypropylene | 87 | 96 |
| Carrier Resin (Jinshan) | | |
| Arosperse 11 Beads carbon | 10 | |
| black pigment (Evonik) | | |
| Nanocyl NC7000 carbon | | 3 |
| nanotubes (Nanocyl) | | |
| Fine-Blend SAG-002 | | 1 |
| dispersion agent (SUNNY | | |
| FC) | | |
| A-C Polyethylene 6A | 3 | |
| Dispersion agent | | |
| (Honeywell) | | |
| Wt. % Total | 100 | 100 |

Example 2 and Comparative Example B were compounds made from masterbatches of Example 1 and Comparative Example A, respectively, by melt-mixing the masterbatch with polymer resin at a temperature of 190-230° C. using a twin screw extruder which formed pellets. The pellets were then molded into test plaques using a smooth surface mold in an injection mold machine with a mold temperature of 50° C.

The two compounds were then tested for L* Value using DATA COLOR DC650 machine and ASTM E 1347-06 D65/10° test method. Table 4 shows the compound formulations and the L* Value results.

TABLE 4

| | Comparative | |
|---|---|---|
| Ingredient (Wt. %) | Example B | Example 2 |
| PP-Y-3700 Polypropylene Resin (Jinshan) | 90 | 99 |
| Masterbatch of Comparative Example A | 10 | |
| Masterbatch of Example 1 | | 1 |
| Wt. % Total Compound | 100 | 100 |
| Wt. % Content of Carbon Black or Carbon | 1 | 0.03 |
| Nanotubes, respectively, in final | | |
| compound. | | |
| L* Value of Carbon Black or Carbon | 13.71 | 6.93 |
| Nanotubes, respectively (L* value was | | |
| tested by Datacolor D65/10°with 100% | | |
| compressed colorants.) | | |
| L* Value of Compound | 25.63 | 23.80 |

Example 2 has thirty-three times less carbon pigment content and yet achieves a better L* Value than Comparative Example B. A visual comparison between the two plaques can see a clear distinction of darkness between 23.80 of Example 2 vs. 25.63 of Comparative Example B. The L* value differential between carbon black and carbon nanotubes alone cannot be the basis for the better L* value of the compounds. These results are unexpected and not predictable.

It is known conventionally that addition of up to 2 wt. % of carbon black will not reduce the L* Value below about 23. Thus, carbon nanotubes are unexpectedly superior black pigment particles for use in making thermoplastic articles to have a darker color, about as much blackness on the gray scale as can be achieved in thermoplastic articles, even if additional carbon pigment were to be used.

While not being limited to a particular theory, it is believed that the much lighter density of carbon nanotubes compared with carbon black, weight per unit volume, allows for more blackness per unit volume of the thermoplastic compound

The invention is not limited to the above embodiments. The claims follow.

What is claimed is:

1. A masterbatch, comprising:
(a) thermoplastic resin and
(b) carbon nanotubes,
wherein, when let down into additional thermoplastic resin to form a polymer compound, the carbon nanotubes provide substantially the same or smaller L* Value of blackness as does carbon black with about thirty times less weight percent of carbon nanotubes compared with carbon black.

2. The masterbatch of claim 1, wherein the thermoplastic resin comprises polypropylene (PP), polyethylene(PE), polyvinyl chloride (PVC), polycarbonate (PC), acrylonitrile-butadiene-styrene (ABS), polyethylene terephthalate (PET), polybutylene terephthalate (PBT), polyoxymethylene (POM), polyamide (PA), polystyrene (PS), polymethylmethacrylate (PMMA), polyphenylene sulfide (PPS) or polylactic acid (PLA), any copolymer of any of them, or any combination thereof.

3. The masterbatch of claim 1, further comprising a functional additive selected from the group consisting of fragrances, colorants, ultraviolet or visible light absorbers, lubricants, anti-static agents, antimicrobial agents, and combinations thereof.

4. The masterbatch of claim 1, wherein further comprising an inorganic filler selected from the group consisting of talc, mica, barium sulfate, titanium dioxide, calcium carbonate, silicon dioxide, and combinations thereof.

5. A polymer compound, comprising:
(a) the masterbatch of claim 1;
(b) thermoplastic resin; and
(c) optionally a functional additive selected from the group consisting of anti-oxidants, anti-stats, acetaldehyde scavengers, blowing agents, surfactants, biocides, exfoliated nanoclays, ultraviolet stabilizers, and combinations of them,
wherein the carbon nanotubes provide substantially the same L* Value of blackness as does carbon black with about thirty times less weight percent of carbon nanotubes compared with carbon black.

6. The compound of claim 5, wherein the thermoplastic resin is selected from the group consisting of polypropylene (PP), polyethylene (PE), polyvinyl chloride (PVC), polycarbonate (PC), acrylonitrile-butadiene-styrene (ABS), polyethylene terephthalate (PET), polybutylene terephthalate (PBT), polyoxymethylene (POM), polyamide (PA), polystyrene (PS), polymethylmethacrylate (PMMA), polyphenylene sulfide (PPS), polylactic acid (PLA), any copolymer of any of them, and any combination thereof.

7. The compound of claim 5, wherein the compound further comprises adhesion promoters; biocides; anti-fogging agents; anti-static agents; bonding, blowing and foaming agents; dispersants; fillers, fibers, and extenders; flame retardants; smoke suppressants; impact modifiers; initiators; lubricants; micas; pigments, colorants and dyes; plasticizers; processing aids; release agents; silane coupling agents, titanates and zirconates coupling agents; slip and anti-blocking agents; stabilizers; stearates; ultraviolet light absorbers; viscosity regulators; PE waxes; catalyst deactivators, or combinations of them.

8. The compound of claim 5, wherein the amount of carbon nanotubes range from about 0.01 to about 10% weight percent of the compound.

9. A method of making a masterbatch of claim 1, comprising the step melt-mixing thermoplastic resin and carbon nanotubes to form a masterbatch, wherein weight percent of carbon nanotubes are about thirty times less than weight percent of carbon black to achieve substantially the same blackness on the L* gray scale in the CIE-Lab color system.

10. The method of claim 9, wherein the thermoplastic resin comprises polypropylene (PP), polyethylene (PE), polyvinyl chloride (PVC), polycarbonate (PC), acrylonitrile-butadiene-styrene (ABS), polyethylene terephthalate (PET), polybutylene terephthalate (PBT), polyoxymethylene (POM), polyamide (PA), polystyrene (PS), polymethylmethacrylate (PMMA), polyphenylene sulfide (PPS), polylactic acid (PLA), any copolymer of any of them, or any combination thereof.

11. The method of claim 9, further comprising the step (b) of melt mixing the masterbatch with polymer resin and optionally other ingredients to form a polymer compound in its finally-shaped form.

12. The method of claim 11, wherein step (c) is selected from the group consisting of extrusion, molding, spinning, casting, thermoforming, calendering, or 3D printing.
